(19) United States
(12) Patent Application Publication
(10) Pub. No.: US 2007/0213988 A1
(43) Pub. Date: Sep. 13, 2007

(54) Using speech processing technologies for verification sequence instances

(75) Inventor: Gary R. Hanson, Boynton Beach, FL (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, Armonk, NY (US)

(21) Appl. No.: 11/372,524

(22) Filed: Mar. 10, 2006

(51) Int. Cl. G10L 21/00

(52) U.S. Cl. 704/275

(57) ABSTRACT

A method for verifying sequential steps using speech processing technologies can include a step of initializing a verification sequence instance. The instance sequence can include one or more sequentially linked verification points. A computer produced speech prompt can be presented for one of the verification points. A speech response can be received from a verifier for the verification point. The speech response can be automatically converted to a text response. The text response can be stored in a response log for the verification sequence instance. The next verification point in the verification sequence instance can be determined. The presenting, receiving, converting, and storing steps can be performed for the new verification point. This method can be repeated until the verification sequence instance is complete.

### BACKGROUND

1. Field of the Invention

The present invention relates to the field of speech processing and, more particularly, to using speech processing technologies for verification sequence instances.

2. Description of the Related Art

A verification sequence instance includes a series of previously established prompts, each of which requires one or more user responses. Each prompt-response combination is referred to herein as a verification point. Verification sequence instances have many applications, including check lists, test plans, and surveys. For example, a check list is a series of steps that must be verified. For each step, a checklist verifier determines whether the step is satisfied or not. Each failed test often requires additional annotations relating to why that step failed. Sometimes immediate corrective action(s) can be taken to place a system in a satisfactory state. Other times, a signification repair or renovation may be required.

It is common for maintenance personnel, such as airline maintenance workers, and operators of dangerous machinery, such as airline pilots, to complete checklists before equipment for which they are responsible to be released for operational use.

In another example, a customer return center can evaluate returned merchandise using a checklist. Similarly, a quality control tester can sample items from a manufacturing run and use a checklist to ensure that the sampled item meets or exceeds standards. Another common verification sequence instance is a software test plan. A software test plan includes a series of verification points (tests) that a verifier (software tester) is to perform.

Traditional verification sequence instances are often paper documents that require manual verification at each step. These paper documents are generally collected and converted into a database form for storage.

Another way to execute a verification sequence instance is to use graphical user interface (GUI) and an interactive or fillable form. The GUI can be part of a stationary system, such as a computer system used for recordation purposes by a software tester. The GUI can also be part of a mobile system, such as a tablet PC or embedded PC, used by an airline maintenance worker or airline pilot, for responding to a graphically displayed checklist.

These visual verification sequence instances have many weaknesses. For example, a verifier is often performing task requiring visual verification of an equipment state. Shifting eye focus back and forth between a visually displayed verification sequence instance (check list or software test plan) and a system or piece of equipment is inefficient and can result in steps being skipped or in evaluation errors.

Verification sequence instances that use GUIs have an additional problem of encumbering a user's hands, which may be required for a verification task, which again adds to inefficiencies and user errors.

Additionally, visual interfaces permit task aggregation and permit a verifier to alter a sequence in which verification points are examined. Task aggregation is writing a prompt that has multiple independent steps each of which require verification. For example, a single verification point can require a verifier to examine button color, placement, enablement, and functionality. It is easy for a verifier to overlook one portion of an aggregated prompt. Further, aggregated responses often produce ambiguous results.

Verification sequence instances are designed to be conducted in a stepwise fashion from one verification point in a sequence to the next. Written prompts allow a verifier to see other prompts in a sequence and to respond in a non-stepwise fashion. For example, a verifier can respond to step one, then step five, and then return to steps three and four. This inherent lack of procedural integrity with writing instruments is generally referred to as a problem with the omni-directional nature of reading/writing. In contrast, speech prompts and speech responses are inherently unidirectional, requiring a verifier to complete one step, before being presented with the next. It should be appreciated that when prompts are intended to be performed in a particular order, changing this order can have negative consequences. Additionally, when a verifier is exposed to future prompts, there is a tendency to bias responses based upon verifier desired outcomes.

### SUMMARY OF THE INVENTION

The present invention discloses a verification sequence instance conducted by an automated system where each verification point is presented as a speech prompt and responded to by a speech response. Speech responses can be automatically speech-to-text converted and text converted responses can be stored. Conditional branching operations can be performed, when necessary, to determine the next verification point to present.

Using speech input/output for a verification sequence instance can have many advantages over traditional methodologies. For example, throughput for the instance can be increased because a verifier does not have to divert attention between a visual checklist or test plan and a system that requires visual verifications. Throughput can also be increased because the verification can be performed in a hands free fashion. Tables, platforms, and computing devices necessary to hold writing utensils and/or GUI interfaces can be eliminated, sating space in a verification environment and increasing verifier mobility. Further, audible prompts and responses can enforce procedural integrity by requiring a stepwise or unidirectional performance of a verification sequence instance. Even when instructions are presented to conduct a GUI or paper based verification sequence instance in a stepwise fashion, these instructions can be circumvented by the omni-directional nature of reading/writing.

The present invention can be implemented in accordance with numerous aspects consistent with material presented herein. For example, one aspect of the present invention can include a method for verifying a sequence instance. The method can include a step of initializing a verification sequence instance. The verification sequence instance can include one or more sequentially linked verification points. A computer produced speech prompt can be presented for one of the verification points. A speech response can be received from verifier. The speech response can be automatically converted to a text response. The text response can be stored in a response log for the verification sequence instance. The next verification point in the verification sequence instance can be determined. The presenting, receiving, converting, and storing steps can be performed for the new verification point. This method can be repeated until the verification sequence instance is complete.

Another aspect of the present invention can include a software method including a step of audibly presenting one or more speech prompts corresponding to a sequenced verification point. For each verification point, said speech prompts can specify an action that a verifier is to take for that verification point. For each verification point, a speech response can be received that corresponds to a status of the action. A log can be generated that records status information for each verification point.

Still another aspect of the present invention can include a system for verification sequence instances. The system can include a sequence server, a sequence client, and at least one speech processing engine. The sequence server can manage one or more verification sequence instances and can store at least one instance log. Each verification sequence instance can include one or more verification points. Each verification point can have an associated action that a verifier is to take for that verification point. The sequence client can be communicatively linked to the sequence server. The sequence client can include a speech interface through which a speech prompts specifying the associated actions are presented to the verifier and through which speech responses corresponding to a status for each action are received. The speech processing engine can speech-to-text convert the speech responses. For each completed verification sequence instance, speech responses can be received for each verification point for which a speech prompt was generated. For each completed verification sequence instance, a textually converted form of the speech responses can be stored within a data store accessible by the sequence server as an instance log for the completed verification sequence instance.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a system for completing verification sequence instances using speech processing technologies in accordance with an embodiment of the inventive arrangements disclosed herein.

FIG. 2 illustrates a verification point in accordance with an embodiment of the inventive arrangements disclosed herein.

FIG. 3 illustrates spoken user commands to which a system for verification sequence instances can respond in accordance with an embodiment of the inventive arrangements disclosed herein.

FIG. 4 is a flow chart of a method for implementing verification sequence instances in accordance with an embodiment of the inventive arrangements disclosed herein.

FIG. 5 is a flow chart of a method for presenting verification points and receiving responses to the same in accordance with an embodiment of the inventive arrangements disclosed herein.

### DETAILED DESCRIPTION OF THE INVENTION

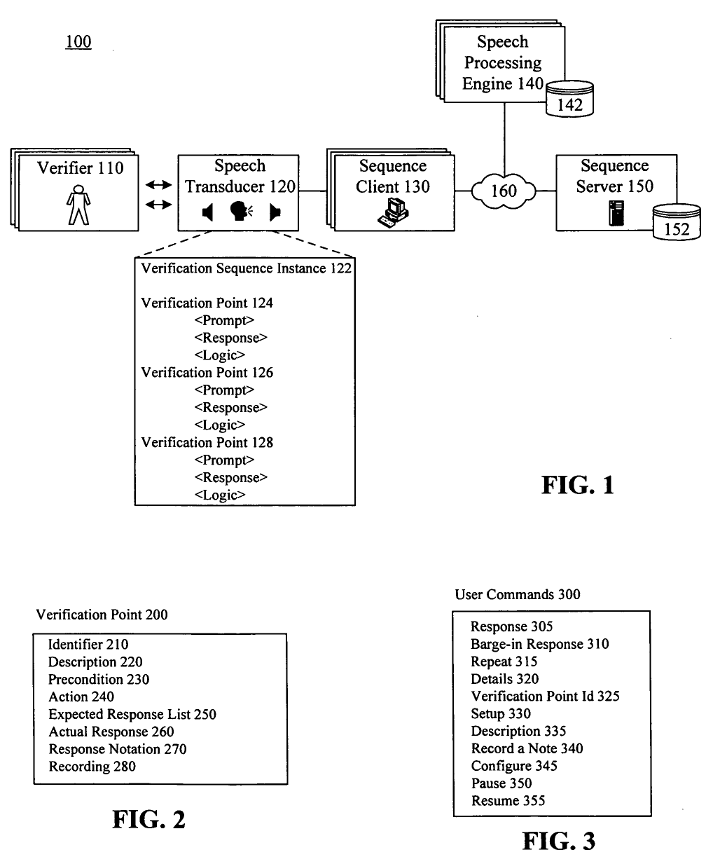

FIG. 1 is a system 100 for completing verification sequence instances using speech processing technologies in accordance with an embodiment of the inventive arrangements disclosed herein. As defined herein, a verification sequence instance can include a series of tasks, each of which requires a response. The tasks can be constructed in a sequential fashion. Responses to various ones of the tasks can result in one or more tasks being skipped. Responses can be logged.

Unlike conventional verification sequence instance systems, system 100 can prompt a verifier using speech prompts and can receive speech responses. Speech prompts and responses have numerous advantages over conventional implementations including permitting a verifier to execute the verification instance in a hands-free fashion without visually distracting the verifier. System 100 also has advantages in procedural integrity, as speech prompts and responses are inherently unidirectional. Further, human verifiers are typically more attentive (according to some studies) to speech prompts that require speech responses than to written verification sequence instances, resulting in more accurate results than those obtained with conventional systems.

In one embodiment, a verification sequence instance can be an instance of a software test plan. A software tester can interact with a graphical user interface (GUI) for the test plan, while receiving speech prompts and providing speech responses. Accordingly, the test plan can be performed with significantly fewer distractions than if a software tester were required to read test prompts from a separate instrument, device, or screen, while performing actions for the software tests, which generally occupy the hands and/or vision of a tester.

In another embodiment, a verification sequence instance can be an instance of a check list, such as an airline maintenance checklist. The maintenance worker can inspect equipment, while receiving speech prompts and while providing speech responses.

Turning to FIG. 1, a verifier 110 can receive speech from audio transducer 120 and can provide speech responses. Verifier 110 can be a human respondent, who responds to a sequence of received speech prompts. The audio transducer 120 can convert electrical signals to audio signals (speech output) and can convert received audio (speech input) into electrical signals. The audio transducer 120 can include a microphone and/or speaker.

The speech prompts and speech responses can be associated with a verification sequence instance 122. The verification sequence instance 122 can represent a checklist instance, a test instance, a survey instance, or any instance where a verifier is prompted for responses to a sequence of tasks/questions. A prompt-response combination can be referred to herein as a verification point.

Accordingly, the verification sequence 122 can include verification points 124, 126, and 128. Each verification point 124-128 can include a prompt section, a response section, and a logic section. The logic section can determine actions to be taken responsive to a prompt and/or actions to be taken responsive to a response. The verification sequence instance 122 can be encoded in any computer readable form, which is able to be executed by sequence client 130. For example, the verification sequence instance 122 can be encoded within XML code, which can be presented within a browser of client 130.

Client 130 can receive electronic signals containing digitally encoded speech from speech transducer 120 and can send electronic signals containing digitally encoded speech to speech transducer 120. Client 130 can be a thin client and/or a thick client. In one embodiment, the speech transducer 120 can be directly connected to client 130, such as when the transducer 120 is a microphone/speaker of client 130. The speech transducer 120 can also be remotely located from, yet communicatively linked to client 130. For example, the speech transducer 120 can be part of a BLUETOOTH headset including a microphone and ear bud that is communicatively linked to sequence client 130.

The sequence client 130 can be linked to at least one speech processing engine 140 and sequence server 150 via network 160. Sequence server 150 can be a centralized server that serves verification sequence instances 122 stored in data store 152 to one or more clients 130. Results from verifiers 110 for the various instances 122 can be referred to as instance response logs, which can be stored in data store 152. In one embodiment, data mining operations can be performed on the instance response logs in data store 152.

Speech processing engine 140 can include one or more text-to-speech engines, and one or more speech-to-text engines. A data store 142 can be used to store speech-to-text grammars and to store text-to-speech voices. Multiple different voices, including male and female voices can be provided.

In one embodiment, different voices, rates of speech, pause duration, recognition dialect, and other speech engine 140 characteristics can be selectively configured by verifier 110 or for verifier 110. In another embodiment, instead of automatically generated speech, a series of prerecorded audio prompts associated with the various verification sequence instances 122 can be stored in data store 142 and used to present speech to verifier 110.

The speech processing engines 140 can be applications local to client 130 and/or server 150. The speech processing engines 140 can also be remotely located engines provided by a speech processing server. The speech processing server can integrate multiple speech processing engines 140 into clusters for handling speech processing tasks.

Network 160 can include any hardware/software/and firmware necessary to convey data encoded within carrier waves. Data can be contained within analog or digital signals and conveyed though data or voice channels. Network 160 can include local components and data pathways necessary for communications to be exchanged among computing device components and between integrated device components and peripheral devices. Network 160 can also include network equipment, such as routers, data lines, hubs, and intermediary servers which together form a data network, such as the Internet. Network 160 can further include circuit-based communication components and mobile communication components, such as telephony switches, modems, cellular communication towers, and the like. Network 160 can include line based and/or wireless communication pathways.

Data stores 142 and 152 can each be a physical or virtual storage space configured to store digital information. Each of data stores 142 and 152 can be physically implemented within any type of hardware including, but not limited to, a magnetic disk, an optical disk, a semiconductor memory, a digitally encoded plastic memory, a holographic memory, or any other recording medium. Each of data stores 142 and 152 can be a stand-alone storage unit as well as a storage unit formed from a plurality of physical devices. Additionally, information can be stored within data stores 142 and/or 152 in a variety of manners. For example, information can be stored within a database structure or can be stored within one or more files of a file storage system, where each file may or may not be indexed for information searching purposes. Further, data stores 142 and 152 can utilize one or more encryption mechanisms to protect stored information from unauthorized access.

It should be appreciated that the arrangements shown in system 100 are for illustrative purposes only and that the invention is not limited in this regard. The functionality attributable to the various components can be combined or separated in different manners than those illustrated herein. For instance, the functionality of the sequence client 130, the sequence server 150, and the speech processing engine 140 can be implemented as a single hardware/software component in another contemplated arrangement of the present invention.

FIG. 2 illustrates a verification point 200 in accordance with an embodiment of the inventive arrangements disclosed herein. The verification point 200 can be one implementation of a verification point 124-128. Verification point 200 can include, but is not limited to, identifier 210, description 220, precondition 230, action 240, expected response list 250, actual response 260, response notification 270, and/or response recording 280.

The invention can include numerous configurable parameters related to the verification points and verification sequences. These configurable parameters can permit a user (or verifier) to adjust a presentation and/or recognition parameter of a speech processing system that presents verification point information. For example, a pace of speech, a gender of speech, a quality of a system generated voice, a dialect of a speech recognition engine, a speech processing language, and the like can be adjusted. Similarly, prompts can be presented in a verbose or shortened format at a preference of a user. Users, however, are not able to change the content of a verification point, a set of valid responses for a verification point, or the logic through which the verification points of a verification sequence are presented. Accordingly, the present invention ensures procedural integrity of a verification sequence while permitting users to adjust system parameters related to presentation and interface preferences.

The identifier 210 uniquely identifies a particular verification point 200. The verification point 200 may have a name associated with it as well as a number. When a verification point 200 is attempting to verify a condition of a print button, the identifier 210 can be “print_button_test_one,” “PB_T1,” “test00012,” and other such values. A system using verification point 200 can be configured by a user to present, hide, or alter the presentation of identifier 210. For example, an ordinal position of a verification point 200 can be provided, such as task five of ten, instead of presenting an actual identifier 210 to a verifier.

Description 220 provides a general description for a task associated with the verification point 200. For example, description 220 can include “Print button appearance test” or other such value. A system using verification point 200 can be configured to so that the description is always skipped, always presented, or presented on demand.

Precondition 230 or set-up condition can provide a series of steps that need to be conducted before a current step. Precondition 230 steps can be linked to other verification points. Precondition 230 steps can also specify a series of previously untested conditions that must be enabled before a verification point 200 condition can be evaluated. A system can be configured to present preconditions 230 in many different fashions.

For example, a system can be configured to always provide a short description of the precondition 230 followed by detailed instructions. The system can be configured to provide a short description for a precondition 230 and to provide detailed instructions only when prompted for. Detailed instructions for preconditions 230 can be particularly advantageous for new verifiers, for new verification points, and/or for existing verification points having newly modified preconditions 230.

Action 240 represents an action or a sequence of actions that a verifier is to take. Action 240 can be designed to elicit a response for a particular verification point. The response being a response from a user relating to the system under test. For example, an action 240 for print button appearance could include “Check to see if the print button is presented, is enabled, and is readable.” A system will generally enunciate an action 240 (non-configurable) to minimize a chance of verifier confusion. The action 240 is generally not configurable because action 240 is attempting to confirm that a response has been correctly understood by a system presenting a verification sequence.

Expected response list 250 provides an elaboration upon and/or one or more examples of an expected response. Expected response list 250 can, for example, cause a system to enunciate “Answer yes or no.” Presentation of expected results can be configured by a verifier, to include a long description for expected responses, a short description, or to not present an expected response. An expected response list 250 can be automatically presented after a sufficiently long pause, when it is assumed that a verifier is not sure of a proper response to provide.

Actual response 260 can represent a text conversion of a received speech response. The actual response can be automatically repeated to ensure that a response was properly understood. Presentation of actual response 260 can be situational. For example, actual response 260 can only be presented when a speech conversion result indicates an accuracy below an established threshold, when a received response was an unexpected response, or when a verifier specifically requests that response 260 be enunciated.

Response notation 270 can permit a respondent to elaborate upon a response. For example, when a software test fails, the respondent can provide a response notation 260 elaborating upon the failure.

Recording 280 can be an audible recording of a response. Recording 280 can be a portion of the user provider audio that is used for voice print analysis and/or user configuration. Recording 280, when used for user verification, can also include images of the respondent, biometric data of the respondent, processed voice print analysis data (which may be not require as much storage space as actual audio samples), and the like.

It should be understood that the purpose of recording 280 is to provide an audit trail of accountability. This audit trail ensures that a user assigned to verify one or more verification points actually performed the verification. The recording 280 can be redundant with other security, and/or authorization mechanisms. For example, any of the verbal responses, and not just the recording 280, can be analyzed to determine a speaker's identify using known voice print analysis techniques.

In one embodiment, additional security features can be implemented for the invention by analyzing user responses using voice stress analysis techniques. Moreover, additional biometrics, such as body shape recognition, fingerprint recognition, and the like can be implemented for the presented invention to enhance security.

To illustrate, a step-by-step re-authentication process can be implemented for enhanced security to prevent one person from initializing a verification sequence and another person from completing the verification sequence. For example, an airplane cockpit verification sequence can use a re-authentication process to ensure that only a captain or other authorized individual can complete a verification sequence. Thus, if a terrorist or other hostile unauthorized person invaded an airplane cockpit, the captain would still have to perform the verification sequence before the plane would be in a state where it could be flown (assuming a critical system is automatically disabled until the cockpit verification sequence is completed). Stress analysis and/or code words can be used in this example to indicate whether the captain was performing the verification sequence under duress.

FIG. 3 illustrates spoken user commands 300 to which a system for verification sequence instances can respond in accordance with an embodiment of the inventive arrangements disclosed herein. User commands 300 can be speech commands received by speech transceiver 120 of system 100. Depending on system implementation, one or more of the user commands 300 can be barge-in commands, meaning that they can be spoken by a verifier as a system is presenting other audio information.

User commands 300 can include, but are not limited to, response 305, barge-in response 310, repeat 315, details 320, verification point identifier 325, setup 330, description 335, record a note 340, configure 345, pause 350, and resume 355. It should be appreciated that the commands 300 are presented to illustrate a general concept of commands applicable for the present invention and are not intended to be construed as an exhaustive listing of commands.

The response command 305 can be a speech response for a verification point. The response command 305 can situationally require a user spoken initialization word, such as “response <user response>.” The initialization word may only be required when the response command 305 is presented as a barge-in. For example, when a system has prompted for a response and is waiting for a reply, the user can reply “verified.”

When the system is proving one or more expected response, the user can barge in with “response verified.”

The barge-in response 310 can be a special response for seasoned testers that do not want to wait for all test information to be enunciated. The barge-in response 310 can require a tester to first provide a key word or phrase to acknowledge the purpose of the response, followed by a response. For example, a barge-in response 310 can include “oil level—full” or “print button appearance—verified.” A barge-in response 310 will not be enabled on many systems, which may require a significant portion of a test be enunciated before a response is permitted.

The repeat command 315 can cause the system to re-enunciate. The repeat command 315 can include optional parameters that alter what is re-enunciated, such as “repeat sentence,” “repeat preconditions,” “repeat step,” and the like.

The details command 320 can cause the system to provide details for the current enunciation. The details command 320 can also cause a system to adjust from a “short” description mode to a “verbose” description mode.

The verification point identifier command 325 can cause the system to enunciate a verification point identifier 325 or a derivative of the verification point identifier 325.

The setup command 330 can cause the system to enunciate preconditions or setup information for a verification point.

The description command 335 can cause the system to enunciate a verification point description.

The record a note command 340 can cause the system to take an audio recording of a verifier supplied note. In one embodiment, speech processing algorithms can automatically extract and distill the audio recording into a short textual form, which can be stored as part of an instance log.

The configure command 345 can cause the system to enter a configuration mode, which allows a user to set preferences. Certain user preferences can be enabled/disabled by a system administrator for a particular user and/or can be selectively allowed based upon a particular project or verification sequence instance.

The pause command 350 can cause the system to pause at a current location. The system can remain in an inactive state but on alert until a user's return.

The resume command 355 can re-active a paused system.

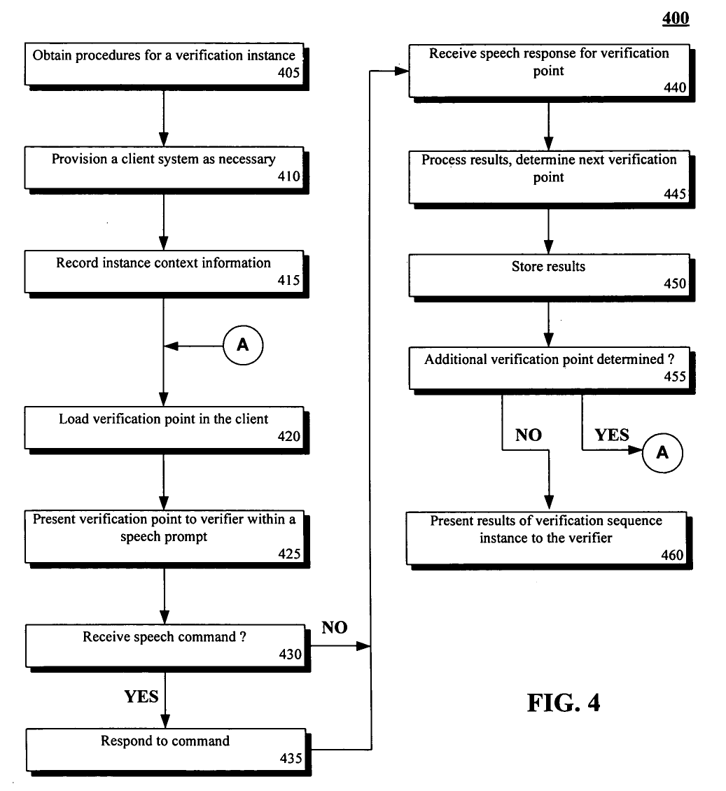

FIG. 4 is a flow chart of a method 400 for implementing verification sequence instances in accordance with an embodiment of the inventive arrangements disclosed herein. Method 400 can be performed in the context of system 100 or any other verification system configured to present speech prompts and to receive speech responses.

Method 400 can begin in step 405, where procedures for a verification instance can be obtained. For example, verification procedures can be stored in a test server or checklist server. In step 410, a client system can be provisioned as necessary for the test. Provisioning the client system may require programs to be loaded on the client system and for resources be allocated specifically for a verification instance. In step 415, instance context information can be recorded. Context information can include a system identifier and configuration, a date and time, verifier information, environmental factors, and other such data.

In step 420, a verification point can be loaded in the client. In step 425, verification point data, such as test number, description, preconditions, action to be taken and expected responses can be presented as speech a verifier. In one embodiment, verification point data can also be visually presented upon a multimodal device, simultaneous with the speech presentation. In step 430, a determination can be made as to whether a speech command is received. If so, the system can progress to step 435, the appropriate actions for that command can be taken. Otherwise, the method can proceed from step 430 to step 440, where a speech response for the verification point can be received.

In step 445, the speech response can be processed. If the process speech response is not recognized as a valid response (not shown), the method can provide a message stating that the response was not understood and can loop to step 425. The processed response can be used to determine the next verification point. In step 450, results from the processed response can be stored in an instance log. In step 455, if additional verification points exist that require user input, the method can loop to step 420, where the next verification point can be presented.

If no additional verification points are required for the verification instance, the method can proceed from step 455 to step 460. In step 460, results of the verification instance can be optionally presented. The user can verify that these results correctly denote that user's responses. The verifier can also be provided with a terminal message, such as “Check list complete. Status operational. Goodbye.” or “Software Test complete. Status Passed.”

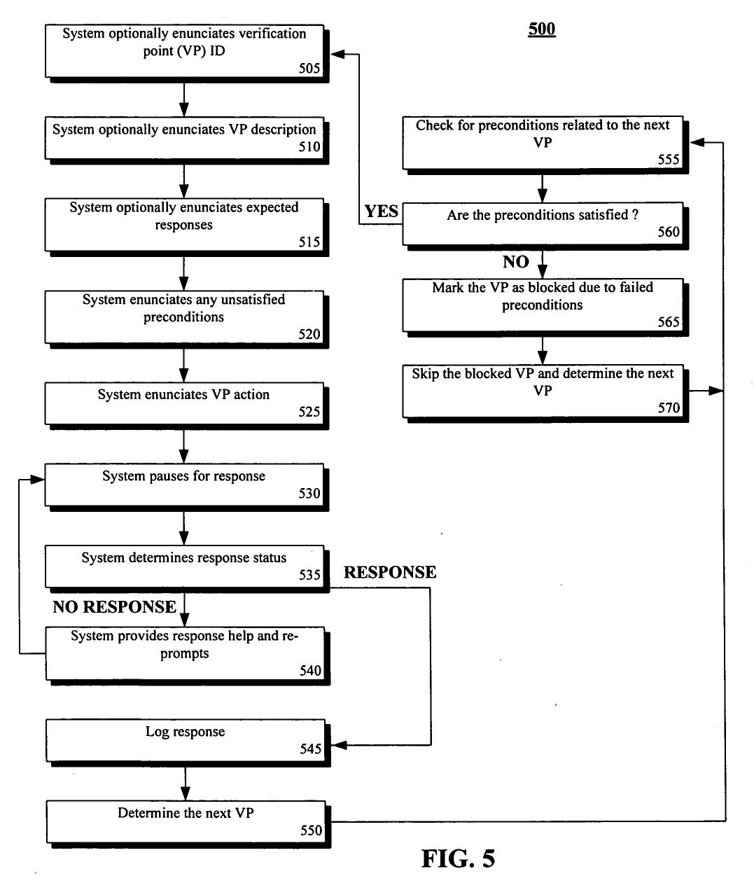

FIG. 5 is a flow chart of a method 500 for presenting verification points and receiving responses to the same in accordance with an embodiment of the inventive arrangements disclosed herein. Method 500 can be performed in the context of system 100 or any other system for one or more verification points that are configured to present speech prompts and receive speech responses. Method 500 utilizes a structure of verification point 200.

Method 500 can begin in step 505, where a verification point identifier can be optionally enunciated. The enunciation can result from a playback of a previously recorded speech message and/or from speech generated by a text-to-speech engine. Additionally, the enunciation can be accompanied by a corresponding visual display for systems having a multimodal interface. In step 510, a verification point description can be optionally enunciated. In step 515, an expected response can be optionally enunciated. When optional enunciations are disabled, they can be selectively re-enabled for a particular verification point by a user command.

In step 520, any unsatisfied preconditions and/or required setup conditions can be enunciated. In step 525, an action to be taken by a verifier can be enunciated. In step 530, the system can pause for a response. In step 535, the system can determine a response status. If no response is received for an established period, the system can assume that a verifier does not understand what input is expected. Thus, the method can progress to step 540, where the system can provide response help, such as providing a list of expected responses. The system can then reprompt a verifier for input and loop to step 530.

If a response is received in step 535, the method can proceed to step 545, where the response is logged. In step 550, a next verification point can be determined. In step 555 the method can check for preconditions related to the next verification point. The next verification point can represent a conditional branch that is dependent upon a previous response. For example, the next verification point can be applicable only when a previous verification point has received a response, only when a previous verification point has resulted in a positive or passed response, or only when a previous verification point has resulted in a negative or failed response. The conditions will depend upon the verification sequence being performed.

In step 560, if the preconditions are satisfied, the method can loop to step 505, where the system can enunciate specifics for the next verification point. If the preconditions are not satisfied in step 560, the method can proceed to step 565. In step 565, the next verification point can be marked as blocked due to failed preconditions. In step 570, the blocked verification point can be skipped, meaning that particulars for that verification point are not enunciated and no response is received for that verification point. After skipping the blocked verification point, the next non-blocked verification point can be determined. The system can loop from step 570 to step 555, where preconditions related to the next non-blocked verification point can be checked.

It should be noted that blocking verification points having unsatisfied preconditions effectively directs a user of the method 500 along a verifiable sequence of verification points. A verifiable sequence being a subset of the verification sequence excluding verification points having failed dependencies. Accordingly, each verification point in the verification sequence can have one of three states, a passed state, a failed state, and a not-attempted state. In a completed verification sequence, none of the verification points should remain in the not-attempted state. For each completed verification sequence, a verifiable sequence can be recorded (as shown in step 545), where each recorded verification point of the verifiable sequence is in a passed state, and where user responses have been provided for each verification point of the verifiable sequence.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method for verifying a sequential sequence comprising:
initializing a verification sequence instance, said instance sequence comprising a plurality of sequentially linked verification points;
presenting a computer produced speech prompt for one of the verification points;
receiving a speech response for the verification point from a verifier;
automatically converting the speech response to text response;
storing the text response in a response log for the verification sequence instance;
determining a next verification point in the verification sequence instance; and
repeating the presenting, receiving, converting, and storing steps until the verification sequence instance is complete.

2. The method of claim 1, in which the received speech response is a barge-in response.

3. The method of claim 1, further comprising:
receiving a speech command from the verifier; and
automatically responding to the speech command.

4. The method of claim 3, wherein the speech command is at least one of a command to repeat a speech prompt, a command to receive additional details associated with the speech prompt, and a command to receive sample answers for the speech prompt.

5. The method of claim 3, wherein the speech command is at least one of a pause command, a resume command, and a command to configure user playback options.

6. The method of claim 1, further comprising:
storing at least a portion of the speech response to later confirm a completion of the verification point by the verifier.

7. The method of claim 1, wherein the verification sequence instance comprises a software test.

8. The method of claim 1, wherein a computing device presents the speech prompts and receives the speech responses, wherein the computing device is a computing device executing software that the verifier is testing as part of the software test, whereby the speech prompts and speech responses do not visually interfere with GUI aspects of the software test being conducted on the same computing device.

9. The method of claim 1, wherein the verification sequence instance comprises an equipment checklist.

10. The method of claim 1, wherein at least one of the verification points, requires the verifier to visually examine an item other than a visual rendering of a verification point prompt.

11. The software method of claim 1, wherein said steps of claim 1 are performed by at least one machine in accordance with at least one computer program having a plurality of code sections that are executable by the at least one machine.

12. A software method comprising the step of:
audibly presenting a plurality of speech prompts corresponding to a plurality of sequenced verification points, for each verification point, said speech prompts specifying an action that a verifier is to take for that verification point;
for each verification point, receiving a speech response corresponding to a status of the action; and
generating a log recording status information for each verification point.

13. The software method of claim 12, wherein the sequence of verification points are each testing steps of a software test plan.

14. The software method of claim 12, wherein the sequence of verification points are each validations steps associated with an equipment checklist.

15. The software method of claim 12, further comprising:
visually presenting content of the speech prompts to the verifier; and
visually presenting content of the speech responses to the verifier.

16. The software method of claim 12, wherein each verification point comprises an identifier, a description, a precondition, an action, and an expected response.

17. The software method of claim 16, wherein each verification point comprises an expected response list, and a recording.

18. The software method of claim 12, further comprising:
receiving a spoken user command selected from a repeat command, a details command, a verification point identifier command, a setup command, a description command, a record a note command, a configure command, a pause command, and a resume command.

19. The software method of claim 12, wherein said steps of claim 12 are performed by at least one machine in accordance with at least one computer program having a plurality of code sections that are executable by the at least one machine.

20. A system for verification sequence instances comprising:
a sequence server configured to manage a plurality of verification sequence instances and configured to store a plurality of instance logs, wherein each verification sequence instance comprises a plurality of verification points, each verification point having an associated action that a verifier is to take for that verification point;
a sequence client communicatively linked to the sequence server, said sequence client including a speech interface through which a speech prompts specifying the associated actions are presented to a verifier and through which speech responses corresponding to a status for each action are received; and
at least one speech processing engine configured to speech-to-text convert the speech responses, wherein for each completed verification sequence instance speech responses are received for each verification point for which a speech prompt was generated, wherein for each completed verification sequence instance, a textually converted form of the speech responses is stored within a data store accessible by the sequence server as part of an instance log.
